(19) United States
(12) Patent Application Publication
(10) Pub. No.: US 2015/0076817 A1
(43) Pub. Date: Mar. 19, 2015

(54) COMPOSITE SLIDING GASKET FOR HIGH-PRESSURE JOINTS

(71) Applicant: Giuseppe Bizzarrini, Pioltello (MI) (IT)

(72) Inventor: Giuseppe Bizzarrini, Pioltello (MI) (IT)

(73) Assignee: COES COMPANY SRL, Pioltello (Ml) (IT)

(21) Appl. No.: 14/396,456

(22) PCT Filed: Apr. 24, 2012
(86) PCT No.: PCT/IT2012/000118

§ 371 Date: Oct. 23, 2014

(51) Int. Cl. F16L 21/035; F16L 41/08; F16L 33/18

(52) U.S. Cl. CPC F16L 21/035; F16L 33/18; F16L 41/08
USPC 285/374

(57) ABSTRACT

A composite sliding gasket for joints of high-pressure pipes is basically formed by a rubber part and by a rigid ring—having the function of flange—that is designed to draw the gasket itself from a resting position or seat to a working position or seat by an external pipe or hole that is axially fitted on an internal pipe or barbed fitting. Compression of the rubber part of the gasket, which guarantees fluid tightness, is obtained thanks to the presence of a purposely provided conical area pre-arranged on the barbed fitting between the resting seat and the working seat. The gasket includes a rubber ring fixedly coupled to a coaxial flange made of rigid material of plastic or metal or other suitable material, the gasket being designed to seal a coupling with play between the internal pipe and the hole within which a pressurized fluid can flow.

The present invention relates to the sector of gaskets for high-pressure pipes, and in particular regards an innovative sliding gasket.

According to the current known art, sealing of couplings between a hollow shaft and a hole is commonly ensured by toroidal rubber gaskets housed in annular slots made on the outer surface of the shaft. The section of the rubber torus prior to assembly projects from the slot where it is housed.

During assembly, the cross section of the gasket is compressed within the slot enabling sealing. The compression of the gasket occurs thanks to a chamfer made on the rim of the hole. The compressive stress depends upon the angle of the chamfer: the smaller the angle of the chamfer, the lower the compressive stress.

For technological reasons, the angle of the chamfer cannot be less than 30°.

It should also be noted that, if the hole belongs to a pipe that needs to be cut to size, it happens that the hole is ovalized during the cutting operation, and the chamfer must be made at that moment, after cutting and prior to assembly. For this purpose, a tool must be used formed by an expander plug that calibrates the ovalized hole and by a mill that makes the chamfer. There frequently arises the condition where this operation is performed badly or even omitted. In these conditions, the compressive load on the gasket becomes very high, the sharp edge of the hole can damage the gasket or cause exit thereof from the seat, and the surface of the shaft that interferes with the ovalized hole can damage the inner surface of the hole jeopardizing fluid tightness of the joint.

Known to the art are some solutions aimed at reducing these problems.

The patent No. EP0854997B1, regarding a composite gasket, eliminates the need for seats on the shaft: there is no metal contact between the shaft and the hole during assembly. This solution increases, however, the insertion load, requires a chamfer on the rim of the hole performed in a workmanlike manner and, in the event of disassembly, the gasket tends to remain within the hole creating a series of additional problems for extracting the gasket.

The patent No. EP1983245A1 regards a particular profile of the shaft that eliminates the interference between the hole and the gasket, but requires the inner surface of the hole to be deformed after assembly in order to compress the gasket radially. This solution solves the majority of the problems but only limitedly to the case where the hole of the pipe can be deformed easily. In addition, the deformation of the pipe (pressing) is a complex operation that requires particular equipment.

The main purpose of the present invention is to overcome the aforesaid problems, to eliminate the conditions of malfunctioning of the gasket after assembly between the shaft and the hole, as well as to eliminate the need for calibrating, chamfering, and pressing tools.

The purpose of the above is to enable correct and safe assembly without the need for particular equipment and in general reducing to a technically possible minimum the assembly load, moreover enabling an easy visual inspection of correct positioning of the gasket when assembly is completed.

The above has been achieved, according to the invention, by providing a composite gasket formed substantially by a rubber part and by a rigid ring (e.g., made of plastic, metal, etc.)—having function of flange—which is designed to draw the gasket itself from the resting position to the working position by the external pipe or hole that is axially fitted on the internal pipe or barbed fitting. Compression of the gasket that guarantees fluid tightness occurs thanks to the presence of a purposely provided conical area on the barbed fitting.

A better understanding of the invention will be obtained from the ensuing description and with reference to the attached drawings, which illustrate, purely by way of non-limiting example some preferred embodiments.

In the drawings:

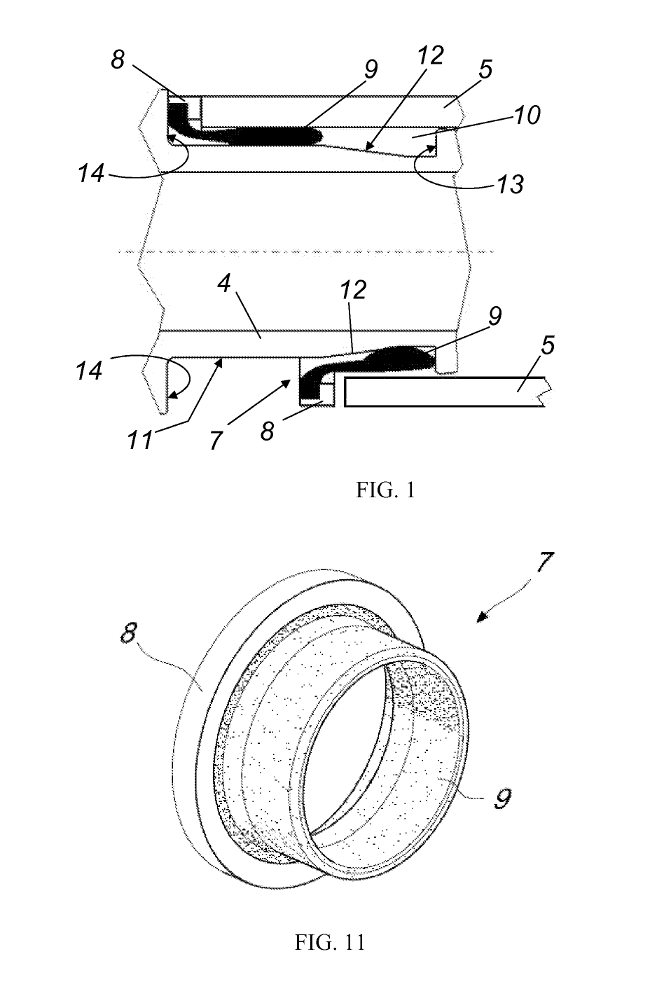

FIG. 1 is a schematic illustration of the inventive idea underlying the invention: the top part shows the gasket in a compressed configuration for guaranteeing tightness, whereas in the bottom part said gasket is in the resting position prior to coupling;

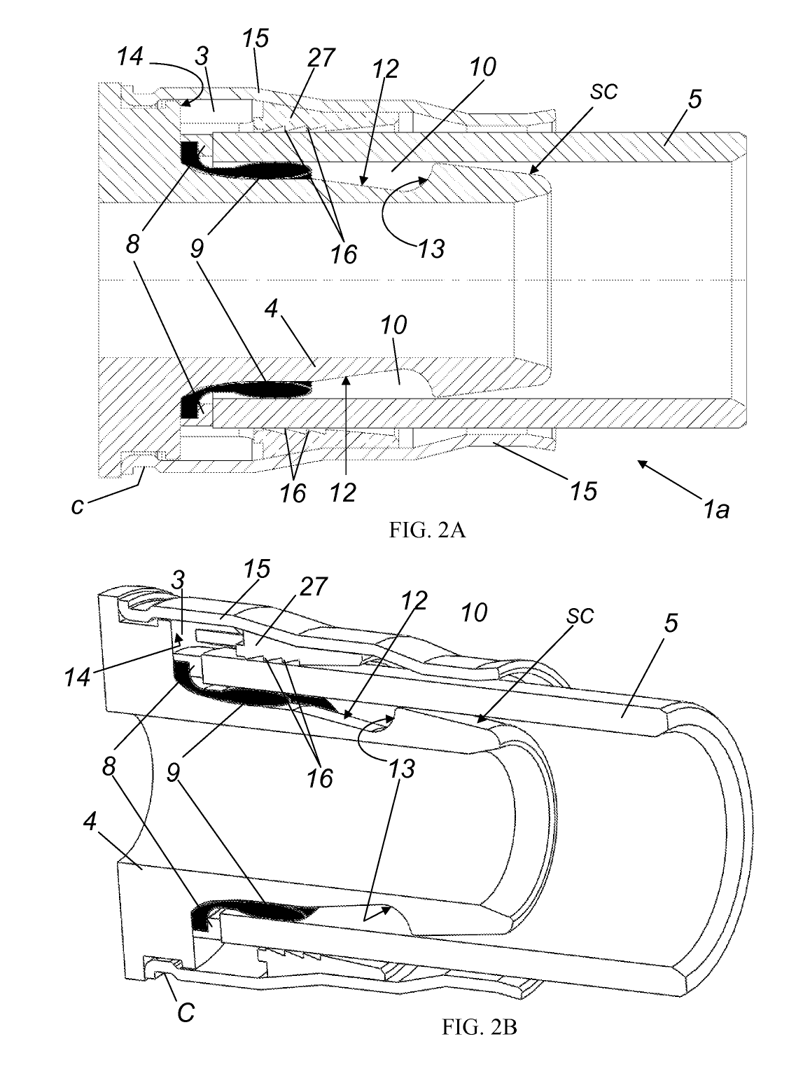

FIG. 2A is an axial sectional view of a first embodiment of a joint with a coupling of the push-fit type with clinched bushing;

FIG. 2B is a three-dimensional view corresponding to the previous one;

FIG. 3A shows some constructional details corresponding to FIG. 2B;

FIG. 3B is an overall side view of the push-fit joint of FIG. 2A;

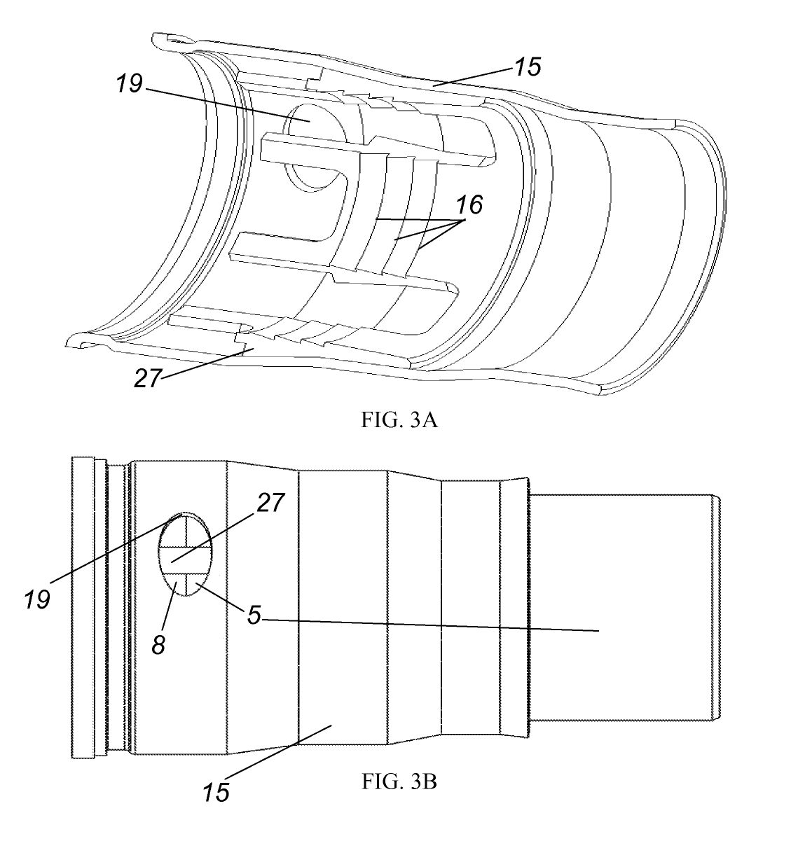

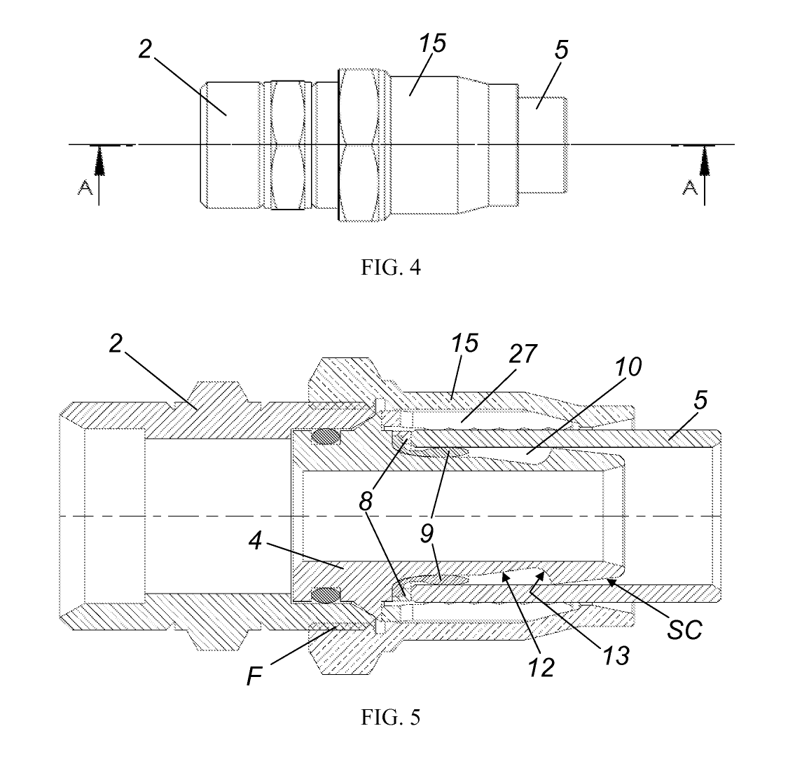

FIG. 4, similar to the previous one, regards a variant of FIG. 2A;

FIG. 5, similar to FIG. 2A, regards a variant that shows a mechanical connector with sliding gasket with threaded bushing;

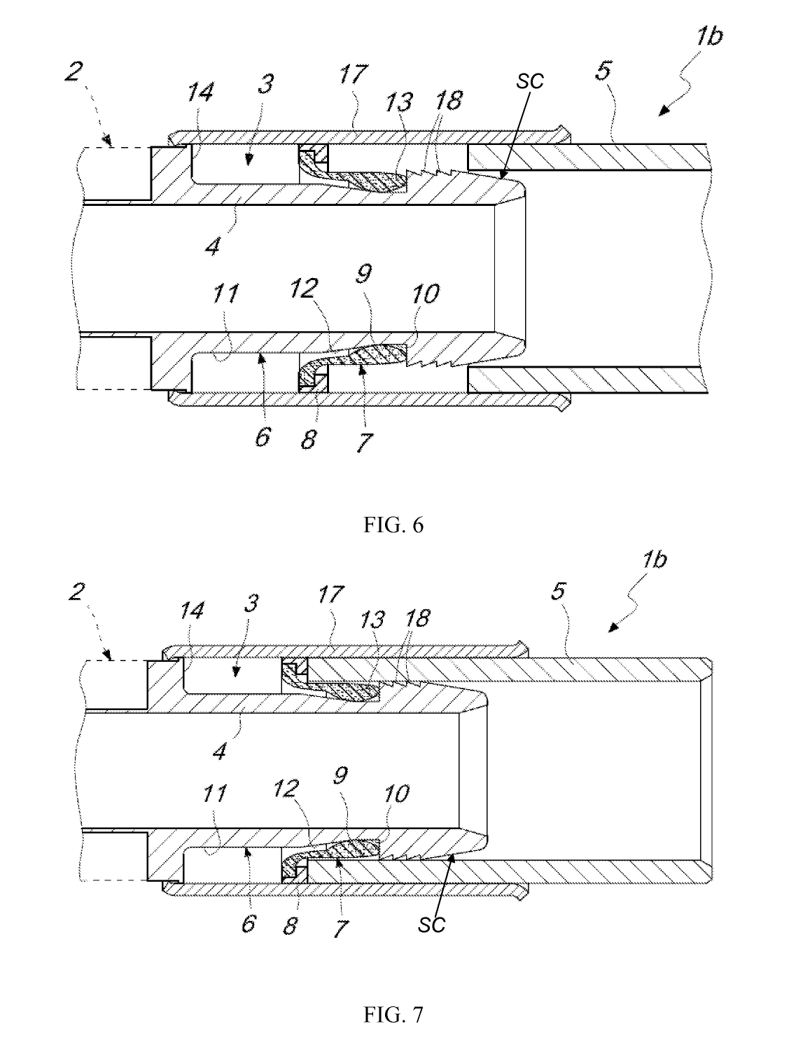

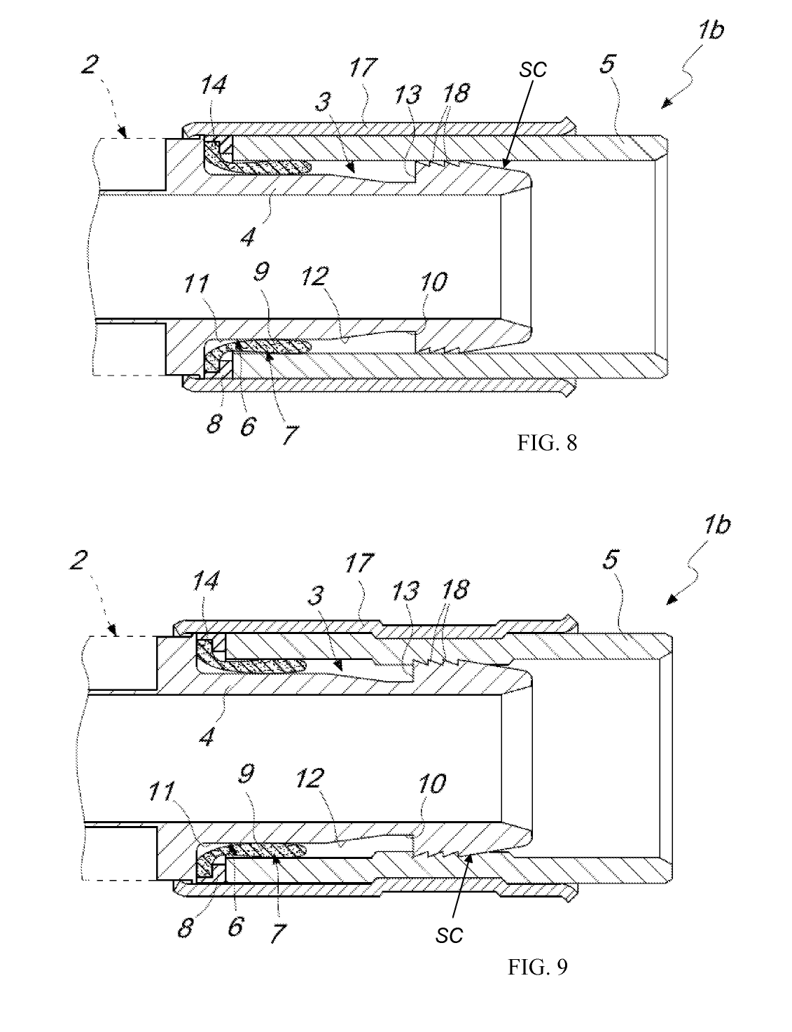

FIGS. 6-9 are views in axial section that show in sequence the coupling steps of a second embodiment of the invention, in which fixing of the joint is of a press-fit type;

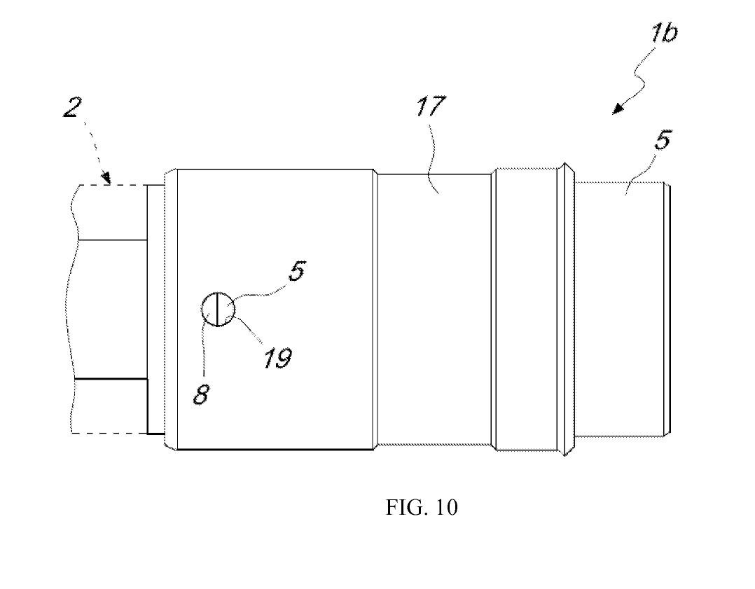

FIG. 10 is an overall side view of the press-fit joint of FIG. 9;

FIG. 11 is a three-dimensional view of the sliding gasket according to the present invention;

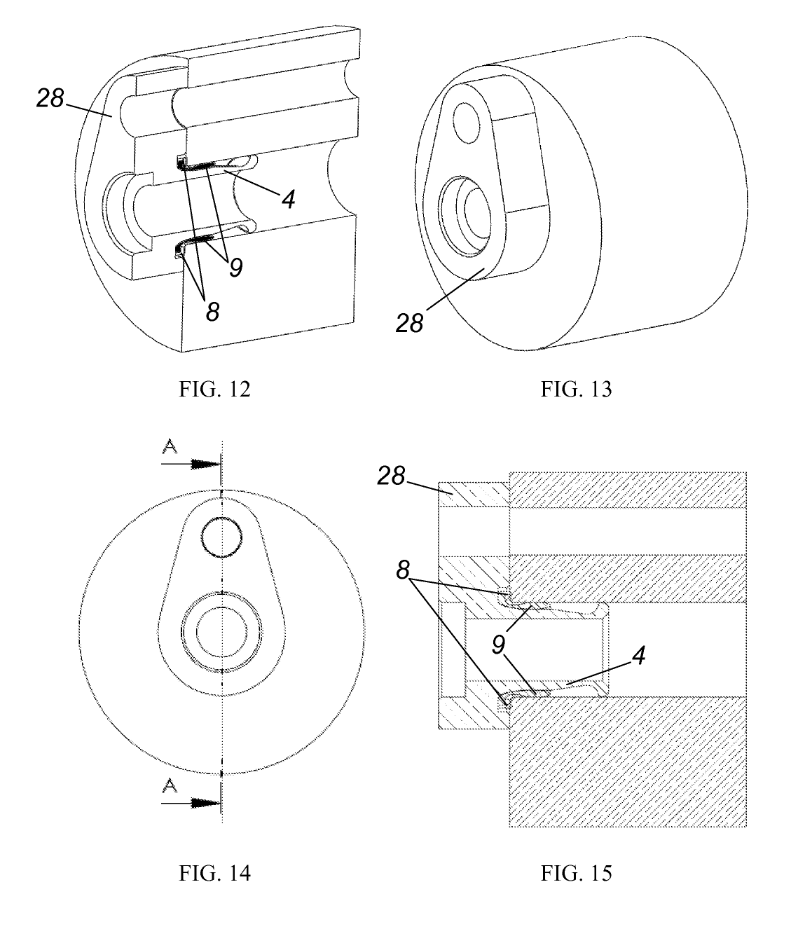

FIGS. 12 and 13 are two three-dimensional views, respectively an axial section and an overall view, of a third embodiment of the invention regarding the case where the barbed fitting is coupled to a hole made in a wall instead of in a pipe; and

FIGS. 14 and 15 are, respectively, a front view and an axial section of the third embodiment of FIGS. 12 and 13.

According to the present invention, a composite gasket 7 is provided, basically constituted by a rubber ring 9 fixedly coupled to a flange made of rigid material 8 (plastic or metal or some other suitable material), said gasket being designed to seal a coupling with play between a hollow shaft 4 and a hole 5 flowing within which is a pressurized fluid.

In a first embodiment of the invention that is described (FIGS. 2A-3B), the gasket 7 is designed for being housed in a circumferential seat 10 made on the outer surface of a hollow shaft or barbed fitting 4, which in what follows will be referred to also as “resting seat 10”, in such a way that the outer diameter of the rubber ring 9 positioned in said seat is smaller than or equal to the diameter of the shaft 4 itself and smaller than the diameter of the hole 5.

According to a peculiar characteristic of the present invention, the resting seat 10 is radiused by a conical ramp 12 to another portion of the shaft 4 that will be referred to as “working seat 11” of the gasket 7. The working seat 11 has a diameter that is greater than the diameter of the resting seat 10 and smaller than the diameter of the shaft 4 itself.

For what has been said, during insertion in the axial direction of the shaft 4 in the hole 5, the rim of the hole 5 engages the flange 8, axially displacing the gasket 7 along the conical ramp 12 from the resting seat 10 to the working seat 11. The rubber ring 9 is progressively compressed between the inner surface of the hole 5 and the outer surface of the shaft 4 as far as maximum compression in the working seat 11, thus ensuring pressure tightness.

In said configuration, the shaft 4 and the hole 5 are fixed together by means of known mechanical devices or systems.

In the example illustrated, the end of the shaft 4 to be inserted in the hole 5 envisages another portion with a specific function: the calibration seat SC. This is a frustoconical area with appropriate inclination suited to restoring the circularity of the hole of a pipe 5 cut to size, where the section of cut is ovalized.

With reference to FIGS. 2A onwards, the calibration seat SC is joined to the adjacent resting seat 11 by means of a shoulder 13, resting on which is the edge of the rubber ring 9 to prevent accidental detachment of the gasket 7 from the barbed fitting 4.

According to the invention, it is envisaged that, once the coupling has been made, the front surface of the flange 8 is set bearing upon a purposely provided shoulder 14 with radial development, which juts out in a direction perpendicular to the end of the working seat 11.

According to the invention, in the case where the hole 5 is made within an external pipe, for fixing axially the parts after their coupling to obtain the joint, a shaped sleeve 15 is provided, which, on the side facing the root of the barbed fitting 4, is provided with a fixing area and, on the opposite side, is provided with a conical seat sliding within which is a conical ring 27 with an internal toothing 16, designed to grip on the outer surface of the aforesaid external pipe 5 to prevent decoupling of the parts and consequent opening of the joint of the push-fit type 1a. In the first embodiment of the invention described, said fixing area of the shaped sleeve 15 is designed to be fixed by clinching C (FIGS. 2A-3B), whereas in a variant of said first embodiment, said fixing area is provided with a thread F (FIGS. 4 and 5).

A further peculiar characteristic of the invention lies in that said shaped sleeve 15 is preferably provided with one or more through holes 19, which are uniformly distributed along a circumference and appropriately positioned in such a way that, when the joint is made, it is possible to verify proper positioning of the gasket 7 with respect to the barbed fitting 4 and to the pipe 5: if the joint is made correctly, visible from the holes 19 is a part of the rigid ring nut 8 and a part of the lateral surface of the external pipe 5 (FIG. 3B).

A second embodiment of the invention, shown in FIGS. 6-10, regards a joint of a press-fit type 1b, which, albeit envisaging axial insertion of the pipe or hollow shaft 4 in the hole 5, differs from the previous case in that, as an alternative to the shaped sleeve 15 described above, an outer tubular sleeve 17 is provided, which, after the sealed joint has been made by means of the axial coupling already described, is designed to undergo plastic deformation in a known way to press radially a purposely provided internal annular area of the pipe 5 against a gripping tooting 18 purposely provided on the outer surface of the calibration seat SC adjacent to the shoulder 13.

Also in this case, the one or more through holes 19 already described are preferably provided.

From what has been said, it emerges clearly that the invention enables an easy and safe assembly of a high-pressure joint without particular equipment for preparing the joint, which can be easily inspected.

This gasket is particularly indicated for those connections between hollow shaft and hole of the push-fitting or press-block-fitting type. These joints enable joining of pipes by just manual pressure. As has already been mentioned, the mechanical resistance of the joint is ensured by a deformable serrated ring that withholds the outer surface of the pipe 5. In these particular joints, during assembly it is necessary to compress the gasket and deform the seal ring. As a result, the assembly load in the solutions so far known can become particularly high, jeopardizing the

1. A sliding composite gasket (7) for joints of high-pressure pipes, characterized in that it is basically formed by a rubber part (9) and by a rigid ring (8)—having the function of flange—which is designed to draw the gasket (7) itself from a resting position or seat (10) to a working position or seat (11) by an external pipe or hole (5) that is axially fitted on an internal pipe or barbed fitting (4) in such a way that compression of the rubber part (9) of the gasket (7), which guarantees fluid tightness, is achieved thanks to the presence of a conical area (12) purposely provided on the barbed fitting (4) between said resting seat (10) and said working seat (11), wherein:
said rubber part is basically constituted by a rubber ring (9) fixedly coupled to a coaxial flange made of rigid material (8) of plastic or metal or some other suitable material, said gasket (7) being designed to seal a coupling with play between the hollow shaft or internal pipe (4) and the hole (5) within which a pressurized fluid can flow;
said gasket (7) is designed for being housed in said resting seat (10) that is circumferential and is made on the outer surface of the barbed fitting (4) in such a way that the outer diameter of the rubber ring (9) positioned in said seat (10) is smaller than or equal to the diameter of the barbed fitting (4) itself and smaller than the diameter of the hole (5);
said resting seat (10) is radiused by a conical ramp (12) to the working seat (11) of the gasket (7) that is provided in another portion of the shaft (4); wherein the working seat (11) has a diameter that is greater than the diameter of the resting seat (10) and smaller than the diameter of the shaft (4) itself;
during insertion in the axial direction of the shaft (4) into the hole (5), the rim of the hole (5) is designed to engage with the flange (8), axially displacing the gasket (7) along the conical ramp (12) from the resting seat (10) to the working seat (11); thus obtaining that the rubber ring (9) is progressively compressed between the inner surface of the hole (5) and the outer surface of the shaft (4) as far as maximum compression in the working seat (11), thus ensuring pressure tightness.

2. The gasket (7) according to claim 1, characterized in that the end of the shaft (4) to be inserted into the hole (5) envisages another portion that functions as calibration seat (SC), constituted by a frustoconical area with appropriate inclination, suited to restoring the circularity of the hole of a pipe cut to size, where the section of cut is ovalized.

3. The gasket (7) according to claim 2, characterized in that the calibration seat (SC) is joined to the adjacent resting seat (10) by means of a shoulder (13) resting on which is the edge of the rubber ring (9) in order to prevent accidental detachment of the gasket (7) from the barbed fitting (4).

4. The gasket (7) according to claim 3, characterized in that, once the coupling has been made, the front surface of the flange (8) is set bearing upon a purposely provided shoulder (14) with radial development, which juts out in a direction perpendicular to the end of the working seat (11).

5. The gasket (7) according to claim 4, characterized in that, in the case where the hole (5) is made within an external pipe, in order to fix the parts axially after their coupling to obtain the joint, a shaped sleeve (15) is provided, which, on the side facing the root of the barbed fitting (4), is provided with a fixing area and, on the opposite side, is provided with a conical seat sliding within which is a conical ring (27) with an internal toothing (16), designed to grip on the outer surface of the aforesaid external pipe (5) to prevent decoupling of the parts and consequent opening of the joint of a push-fit type (1a); said fixing area being axially constrained to the barbed fitting (4) by means of a purposely provided clinching (C) or threading (F).

6. The gasket (7) according to claim 5, characterized in that said shaped sleeve (15) is provided with one or more through holes (19), which are uniformly distributed along a circumference and appropriately positioned in such a way, that when the joint is made properly, visible from each hole (19) is only a part of the rigid ring nut (8) and a part of the lateral surface of the external pipe (5).

7. The gasket (7) according to claim 4, characterized in that, in the case where the hole (5) is made within an external pipe, in order to fix the parts axially after their coupling to obtain the joint, an outer tubular sleeve (17) is provided, which, after the sealed joint has been obtained, is designed to be deformed plastically in a known way to press an appropriate internal annular area of the pipe (5) against a gripping tooting (18) purposely provided on the outer surface of the calibration seat (SC) adjacent to the shoulder (13).

8. The gasket (7) according to claim 7, characterized in that said outer sleeve (17) is provided with one or more through holes (19), which are uniformly distributed along a circumference and appropriately positioned in such a way that, when the joint is made properly, visible from each hole (19) is only a part of the rigid ring nut (8) and a part of the lateral surface of the external pipe (5).

9. A joint for high-pressure pipes, characterized in that it comprises, in combination, an external pipe or hole (5) designed to be axially fitted on an internal pipe or barbed fitting (4), and a composite sliding gasket (7), according to claim 1, set between them.
